(19) United States
(12) Patent Application Publication
(10) Pub. No.: US 2025/0030292 A1
(43) Pub. Date: Jan. 23, 2025

(54) ELECTRIC MOTOR

(71) Applicant: BorgWarner Inc., Auburn Hills, MI (US)

(72) Inventors: Dietmar Metz, Meckenheim (DE); Silvio Koch, Kirchheimbolanden (DE); Dominic Kohlhammer, Heidelberg (DE)

(21) Appl. No.: 18/771,789

(22) Filed: Jul. 12, 2024

(30) Foreign Application Priority Data
Jul. 21, 2023 (DE) 10 2023 119 264.7

(51) Int. Cl. H02K 1/32; H02K 1/20; H02K 1/2786; H02K 5/10; H02K 5/20

(52) U.S. Cl. CPC H02K 1/32; H02K 1/20; H02K 1/2786; H02K 5/10; H02K 5/203

(57) ABSTRACT

An electric motor has a shaft, a stator with windings, and a rotor surrounding the stator and having a back-iron ring. Permanent magnets are arranged on an inner side of the back-iron ring, and a carrier connects the back-iron ring to the shaft. A housing encloses the rotor and the stator and has an opening through which the shaft projects. The carrier has several circulation openings and several flow guide ribs for air circulation in one end face.

### RELATED APPLICATIONS

This application claims priority to DE 10 2023 119 264.7, filed Jul. 21, 2023, the entire disclosure of which is hereby incorporated herein by reference.

### BACKGROUND

This disclosure relates to an external rotor motor with an internally cooled stator and is based on an electric motor generally known, for example, from EP 3 091 637 B1.

The electric motor known from EP 3 091 637 B1 has a cooling channel through which liquid flows and which leads through an interior space surrounded by the stator. In this way, however, no or only insufficient cooling of the permanent magnets of the rotor is achieved. At elevated temperatures, the magnetic properties of the permanent magnets deteriorate, which leads to a reduction in the efficiency of the electric motor.

### SUMMARY

This disclosure shows how the cooling of the permanent magnets of an external rotor motor of the type mentioned above can be improved.

The rotor of an electric motor according to this disclosure comprises a back-iron ring, permanent magnets arranged on an inner side of the back-iron ring and a carrier which connects the back-iron ring to the shaft. This carrier has several circulation openings and several flow guide ribs for air circulation on an axial end face facing away from the stator. In this way, the rotor can cause air circulation during operation, which leads to a more even temperature distribution in the electric motor and thus reduces the temperature of the permanent magnets.

For example, a circulation path may start from the circulation openings and runs from the openings in a radial direction between the housing and the rotor to a circumferential edge of the rotor, then in an axial direction between the rotor and the housing, then around an end of the rotor facing away from the end face and between the rotor and the stator back to the circulation openings.

An advantageous further refinement of this disclosure is that the stator surrounds an interior in which a channel for cooling liquid runs. In this way, two cooling mechanisms can be combined to achieve particularly efficient cooling.

A further advantageous refinement of this disclosure provides that the housing is a sealed housing. For example, the housing may have a first housing part and a second housing part, between which an annular seal is arranged. The housing opening through which the shaft protrudes may, for example, be sealed with a shaft seal.

A further advantageous refinement of this disclosure provides for the flow guide ribs to be arranged in pairs and for flow guide ribs of a pair to define a flow channel between them, for example, a flow channel that leads from one of the circulation openings to a circumferential edge of the support. In this way, particularly efficient air circulation can be achieved.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a sectional view of an embodiment of an electric motor according to this disclosure; and

FIG. 2 shows a view of the rotor of the electric motor.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

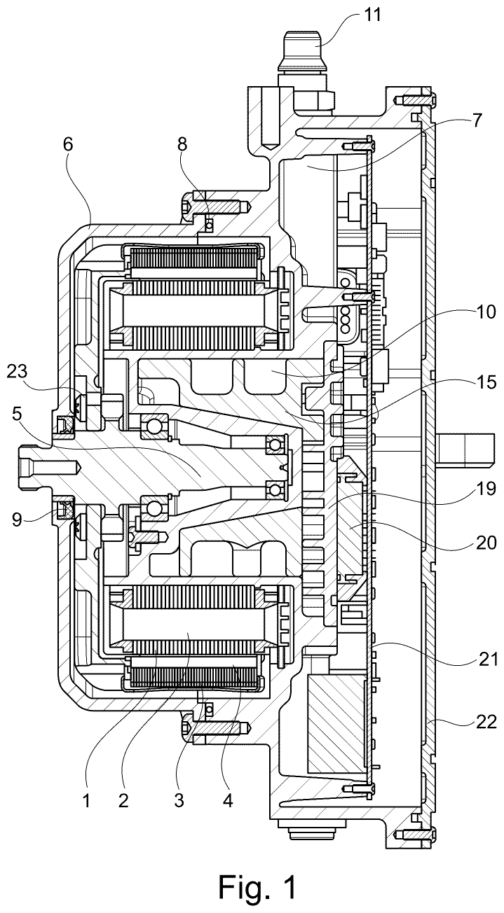

The electric motor shown in FIG. 1 comprises a stator 1 with stator windings 2, a rotor 3 with permanent magnets 4 and a shaft 5 connected to the rotor 3 in a rotationally fixed manner. Rotor 3 and stator 1 are surrounded by a housing that has an opening from which the shaft 5 protrudes.

The housing has a first housing part 6 and a second housing part 7, between which a seal 8 is pressed. The opening through which the shaft 5 protrudes is sealed with a shaft seal 9. The housing is thus sealed against the ingress of liquid water. The first housing part 6 or the housing part 7 may have a pressure equalization opening, which is closed with an air-permeable membrane that is impermeable to liquid water.

The stator 1 surrounds an interior in which a channel 10 for coolant runs. The channel 10 for cooling liquid leads from an inlet 11, which is arranged on the second housing part 7, at an axial end of the stator 1, which extends from the housing opening through which the shaft protrudes, to the interior space surrounded by the stator 1. In the embodiment shown, the first housing part 6 has the opening through which the shaft 5 protrudes, and the second housing part 7 has an inlet 11 and an outlet for cooling liquid. However, it is also possible to provide the opening through which the shaft 5 protrudes as well as the inlet and outlet in the same housing part.

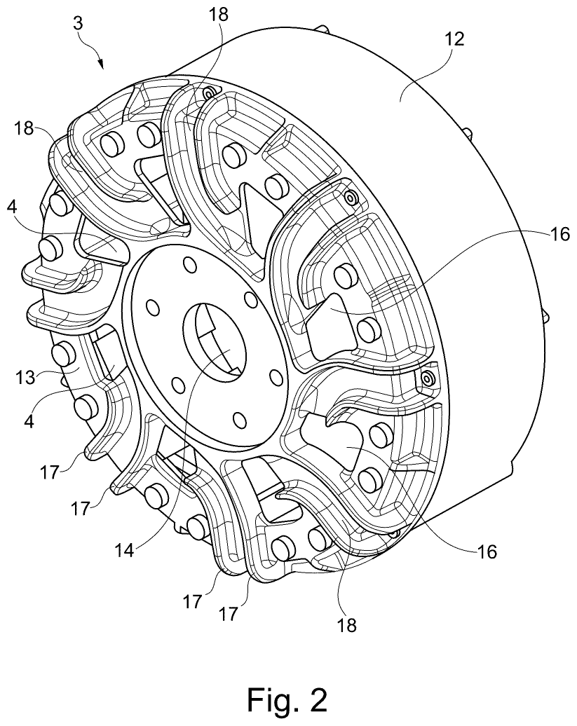

FIG. 2 shows the rotor 3 of the electric motor. The rotor 3 comprises a back-iron ring 12, for example, in the form of a stack of sheet metal, permanent magnets 4, which are arranged on the inside of the back-iron ring 12, and a carrier 13, which connects the back-iron ring 12 to the shaft 5.

The carrier 13 has a hub 14 through which the shaft 5 protrudes. In the embodiment shown, the shaft 5 is attached to the carrier 13 by means of screws 23, but may also be connected to the carrier 13 in other ways, for example, by soldering or welding, or even be made in one piece with the carrier 13.

In its axial end face, which faces the housing side that has the opening for the shaft 5, the carrier 13 has several circulation openings 16 and several flow guide ribs 17 for air circulation. The flow guide ribs 17 each extend from an edge of the end face extending in the circumferential direction, curved towards one of the circulation openings 16. At their inner end, the flow guide ribs 17 point in the direction of rotation towards the circulation openings 16, i.e., they extend in the circumferential direction. At their outer end, the flow guide ribs 17 run in a radial direction. The flow guiding ribs 17 are arranged in pairs; the flow guiding ribs 17 of each of these pairs define a flow channel 18 between them, which leads from a circulation opening 16 to a circumferential edge of the carrier 13.

The flow channels 18 are part of a circulation channel that extends from the circulation openings 16. A first part of the circulation path runs in the flow channels 18, i.e., between the end face of the carrier 13 and the housing. A second part of the circulation path runs from a circumferential edge of the carrier 13 in an axial direction between the rotor 3 and the housing. The circulation path then leads around an axial end of the rotor 3 and between the rotor 3 and stator 1 to the circulation openings 16.

In the electric motor shown, a circulation path therefore emanates from the circulation openings 16, which runs between the housing and the rotor 3, around one end of the rotor 3 facing away from the end face and between the rotor 3 and the stator 1 back to the circulation openings 16. There is thus a gap, for example, a gap of less than 5 mm, such as a gap of 1 mm to 3 mm, between the flow guide ribs 17 and the inside of the housing facing them. The flow guide ribs 17 may, for example, have a height of 2 mm or more, for example, 2 mm to 5 mm. In the embodiment example shown, the circulation openings 16 are located within 60% of the outer diameter of the carrier 3.

The combination of air circulation inside a housing with a liquid-cooled stator 1 enables particularly efficient cooling and thus a powerful electric motor with a compact design. The housing, for example, the first housing part 6, may have ribs on its outside to improve heat dissipation to the ambient air and ribs on its inside to better absorb heat from the air inside the housing. In the embodiment shown, the channel 10 for cooling liquid is realized with an insert 15, which is inserted into the stator 1 and together with the stator 1 defines a section of the cooling channel. A further section of the channel 10 is defined by a plate 19, which delimits a section of the cooling channel 10 between itself and the insert 15 and between itself and the housing part 7. However, the second housing part 7 can also be formed in one piece with the insert 15 and the plate 19.

The other section of the cooling channel 10 can be used to cool electronic components 20 of an electronic control unit. A circuit board 21 of the control electronics is attached to the housing part 7 and covered by a cover plate 22.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SYMBOLS

1 Stator
2 Stator windings
3 Rotor
4 Permanent magnets
5 Shaft
6 Housing part
7 Housing part
8 Gasket
9 Shaft seal
10 Channel
11 Inlet for coolant
12 Short-circuit ring
13 Carrier
14 Hub
15 Insert
16 Circulation openings
17 Flow guide ribs
18 Flow channels
19 Plate
20 Electronic component
21 Printed circuit board
22 Cover plate
23 Screw

What is claimed is:

1. An electric motor, comprising:
a shaft;
a stator comprising stator windings;
a rotor surrounding the stator and comprising a back-iron ring, permanent magnets arranged on an inner side of the back-iron ring and a carrier connecting the back-iron ring to the shaft; and
a housing enclosing the rotor and the stator and having an opening through which the shaft projects;
wherein the carrier has several circulation openings and several flow guide ribs for air circulation in one end face.

2. The electric motor according to claim 1, wherein the flow guide ribs each extend in a curved manner from an edge of the end face extending in the circumferential direction to one of the circulation openings.

3. The electric motor according to claim 1, wherein the flow guide ribs are arranged in pairs and flow guide ribs of a pair define a flow channel between them.

4. The electric motor according to claim 1, wherein the housing has a first housing part and a second housing part, between which an annular seal is arranged.

5. The electric motor according to claim 1, wherein the stator surrounds an interior space in which a channel for cooling liquid runs.

6. The electric motor according to claim 4, wherein the first housing part has the opening through which the shaft projects, and the second housing part has an inlet and an outlet for cooling liquid.

7. The electric motor according to claim 5, wherein the channel for cooling liquid leads along an end of the stator facing away from the end face of the carrier to the interior space surrounded by the stator.

8. The electric motor according to claim 1, wherein the housing has a pressure equalization opening which is closed with an air-permeable membrane which is impermeable to liquid water.

9. The electric motor according to claim 1, wherein a circulation path extends from the circulation openings, which path runs between the housing and the rotor, around an end of the rotor facing away from the end face and between the rotor and the stator to the circulation openings.

10. The electric motor according to claim 1, wherein there is a gap with a thickness of less than 5 mm between the flow guide ribs and the inside of the housing facing them.

11. The electric motor according to claim 1, wherein the flow guide ribs point towards the circulation openings at their inner end in the direction of rotation.

12. The electric motor according to claim 1, wherein the flow guide ribs run in a radial direction at their outer end.

13. The electric motor according to claim 1, wherein the housing has ribs on its outside.

14. The electric motor according to claim 1, wherein the flow guide ribs have a height of at least 2 mm.
